(19) United States
(12) Patent Application Publication
(10) Pub. No.: US 2014/0105784 A1
(43) Pub. Date: Apr. 17, 2014

(54) ULTRAVIOLET TREATMENT DEVICE

(71) Applicant: SHARP KABUSHIKI KAISHA, Osaka-shi (JP)

(72) Inventors: Tim Michael Smeeton, Oxford (GB); Edward Andrew Boardman, Abingdon (GB); Stewart Edward Hooper, Oxford (GB)

(73) Assignee: SHARP KABUSHIKI KAISHA, Osaka-shi (JP)

(21) Appl. No.: 13/651,803

(22) Filed: Oct. 15, 2012

(51) Int. Cl. B01J 19/12

(52) U.S. Cl. CPC B01J 19/12
USPC 422/24; 250/494.1; 250/432 R; 250/435

(57) ABSTRACT

A light source is provided for use in a treatment device for treating a fluid, solid or surface. The light source includes a light emitting diode that emits a first component of ultraviolet (UV) light, and a UV laser light source that emits a second component of UV light having a peak wavelength different from a peak wavelength of the first component of UV light. The first component of UV light and the second component of UV light are applied to treat the fluid or surface. The UV laser light source may include a laser light source and a frequency doubling component that receives light from the laser light source and converts the light to the second component of UV light. A treatment device includes the described light source and a container containing the fluid, or a solid surface, to be treated.

### TECHNICAL FIELD

The present invention relates to a device for treatment of a fluid, solid or surface using ultraviolet light. Furthermore, the invention relates to the sources of ultraviolet light in the device.

### BACKGROUND ART

Ultraviolet (UV) light can be used to sterilize pathogens such as bacteria, viruses, spores and fungi. The UV light causes permanent damage to the pathogens, which renders them unable to reproduce. One application of this effect is to use UV light for sterilization of pathogens in water to make water safe for drinking. Another application is for sterilization of pathogens which are on surfaces to reduce the transmission of disease via surfaces. Another application is for sterilization of air-borne pathogens to reduce transmission of disease through the air (e.g. by aerosol).

UV light can also be used to initiate photocatalytic reactions. In one aspect of this usage, the UV light causes the formations of radicals which have a catalytic effect. One example is the formation of hydroxyl (.OH) radicals in water. Hydroxyl radicals may be formed from the action of UV light on water (H₂O) or hydrogen peroxide (H₂O₂). The hydroxyl radicals can catalyse a series of reactions, which decompose harmful organic compounds (e.g. petroleum or pesticide residues) into harmless chemicals, thereby making water safe for drinking. This is an example of a range of important chemical reactions which are induced by UV light and are generally referred to as Advanced Oxidation Processes (AOPs).

Although all UV light can cause processes such as sterilization of pathogens and inducing photocatalytic reactions, light in the ultraviolet-C (UVC) spectral range is usually the most effective. The UVC spectral range is UV light with wavelength between 200 nm and 280 nm. Within the UVC spectral, range different wavelengths of light can be more effective at causing specific processes than others. For example, in the case of sterilization, light with different UVC wavelengths can cause different mechanisms of damage to the pathogens. FIGS. 1 and 2 are graphical depictions of germicidal action curves for two common and important pathogens. The plot in FIG. 1 shows the dependence of germicidal effectiveness (that is, the effectiveness of the UV light to sterilize the pathogen) on the UV light wavelength for E-coli bacteria as described in DEUTSCHE NORM DIN5031-10 (2000). The plot in FIG. 2 shows the dependence of germicidal effectiveness on the UV light wavelength for an Adenovirus (Ad2) as described in Linden et al., Applied Environmental Microbiology 73(23) p 7571 (October 2007). In the case of inducing photocatalytic reactions, very short wavelengths within the UVC range (e.g., between 200 nm and 230 nm) can be more effective than longer UVC wavelengths (e.g., between 230 nm and 280 nm) for generating hydroxyl radicals. FIG. 3 is a graphical depiction of the absorption of UVC light by hydrogen-peroxide (H₂O₂) (this data is taken from p 152 Photochemical Purification of Water and Air (Oppenländer; Wiley-VCH; 2003)). The increase in hydrogen peroxide absorption for shorter UVC wavelengths correlates with more effective hydroxyl radical formation and thus more effective initiation of photocatalytic reactions by the shorter wavelengths.

There are many examples of conventional systems for treatment of surfaces, air and water which use low-pressure mercury lamps to generate UVC light. The UVC light emitted by low-pressure mercury lamps mainly includes light with a wavelength of approximately 254 nm. Low-pressure mercury lamps are effective for sterilizing pathogens and for inducing photocatalytic reactions. However, there are significant disadvantages to these lamps rendering them less suited to some applications. For example, the lamps contain mercury which is a toxic element, and therefore there is a potential hazard to health and the environment if the lamps are broken during use or disposed of improperly. The lamps are also relatively bulky and fragile, and they perform at their optimum only within a small ambient temperature range. Furthermore, the lifetimes of mercury lamps are too short for some applications, and the lamp lifetime is further shortened by cycling on-and-off. In addition, mercury lamps typically require a “warm-up time” between when they are first switched on and when the UV light output reaches its operating value.

Some or all of these disadvantages of mercury lamps can be overcome by use of solid-state sources of UVC light instead of mercury lamps. Solid-state sources of UVC light can be semiconducting light-emitting diodes (LEDs) or laser diodes, and devices which incorporate semiconductor LEDs or laser diodes. It has proven to be challenging, however, to make LEDs emitting UVC light with high output power and with good efficiency (that is, efficiency of conversion of electrical power into UV light power). In addition, laser diodes have not been employed in the effective generation of UVC light.

Examples have been described using UV LEDs in systems for treatment of surfaces, air or water. For example, Maiden, U.S. Pat. No. 6,579,495 issued on Jun. 17, 2003, describes a device for sterilization of pathogens in water using UV LEDs. Furthermore, Akiko et al, JP2009-194818 published on Mar. 4, 2011, describes a device for water treatment which combines UV LEDs with a mercury lamp. Shur et al., US2007196235 published on Aug. 23, 2007, describes a system for purifying a fluid which contains a UV light emitting diode or UV laser diode and a mercury lamp. Zhu et al., CN102092812 published on Jun. 15, 2011, describes a system for killing microorganisms in water using LEDs emitting a wavelength close to 253.7 nm and a second wavelength close to 185 nm.

FIG. 4 is a graphical depiction of the performance of conventional LEDs emitting UVC light. The plot in FIG. 4 shows the trend of average output power of UVC light for LEDs emitting light with different wavelengths. These data are taken from these publications: Taniyasu et al., Nature 441 p 325 (May 2006); Norimichi et al., physica status solidi (c) No. 6 S459 (Mar. 12, 2009); Hirayama et al., Applied Physics Express No. 1 051101 (May 9, 2008); Hirayama et al., physica status solidi (a) No. 206 1176 (Mar. 25, 2009); Shatalov et al., Applied Physics Express No. 3 062101 (May 28, 2010); and Grandusky et al., Applied Physics Express No. 4 082101 (Jul. 13, 2011). The data in FIG. 4 show that the output power of LEDs in these conventional devices decreases significantly for devices which emit UVC light with shorter wavelengths. The output power of LEDs emitting UVC light with wavelength less than 250 nm is significantly low. Thus, the performance of systems which use UVC wavelengths lower than 250 nm is low and their price is high because many devices are needed to obtain sufficient UVC output power.

Deep UV light can be generated using the process of second harmonic generation. Second harmonic generation is a nonlinear optical phenomenon in which light with wavelength λ is converted to “frequency-doubled” (or, equivalently, “wavelength-halved”) light with wavelength λ/2. Second harmonic generation occurs in materials which have strong second-order nonlinear optical properties. The generation of UVC light using second harmonic generation is reported in Nishimura et al., Japanese Journal of Applied Physics No. 42 p 5079 (Apr. 3, 2003) and Tangtrongbenchasil et al., Japanese Journal of Applied Physics No. 47 p 2137 (Apr. 18, 2008). The UVC output power reported in these publications is less than 10 μW, which is very low and insufficient for most germicidal applications.

In view of the above, conventional devices have not achieved a low-cost and high-performance system using solid-state sources of UV light which can deliver UV wavelengths between 180 nm and 400 nm. In particular, conventional systems using UVC LEDs cannot deliver high power at shorter wavelengths in the UVC spectral band. This means that the effectiveness of conventional systems for processes such as sterilization of pathogens or initiating photocatalytic reactions is deficient.

### SUMMARY OF INVENTION

There is a need in the art for an improved treatment device that delivers a low-cost and high performance system for treatment of a fluid, solid or surface with UV light with wavelengths between 180 nm and 400 nm using solid-state sources of UV light. In particular, the poor performance of conventional UVC LEDs emitting wavelengths shorter than 250 nm means it is not practical to fabricate treatment systems using such conventional LEDs which include these wavelengths shorter than 250 nm. This means that the performance of devices designed for applications such as sterilization of bacteria, viruses, spores or other pathogens is limited. The current invention overcomes such deficiencies of conventional devices.

A device in accordance with the present invention enables treatment of a fluid, solid or surface using wavelengths between 180 nm and 400 nm using solid-state sources of UV light. A UV light source includes one or more light emitting diodes (LEDs) emitting UV light with a peak wavelength greater than or equal to 250 nm and less than or equal to 400 nm. The UV light source further includes one or more UV laser light sources emitting UV light of a wavelength range different from that emitted by the LEDs. In particular, the UV laser light sources include at least one laser light source which emits light with peak wavelength greater than or equal to 360 nm and less than 500 nm. The laser light source may be a laser diode, a solid-state laser, a frequency-doubled laser or another type of laser. The emitted light passes through a frequency-doubling component. As the emitted light passes through the frequency-doubling component, some or all of the emitted light is converted into UV light by a second harmonic generation process. The UV light has a frequency which is two times the frequency of the input light that enters the frequency doubling component (equivalently, the wavelength of the UV light is half the wavelength of the input light). The UV light has a peak wavelength which is determined by the wavelength of the input light that enters the frequency doubling component. Accordingly, the peak wavelength of the UV light is greater than or equal to 180 nm and less than 250 nm. Any of the input light which is not converted into UV light may also be emitted from the frequency-doubling component as unconverted laser light.

If the total power of UV light emitted by the laser light source is denoted Pₗₐₛₑᵣ and the total power of UV light emitted by the LED is denoted P_{LED}, then P_{LED} may be in the range 0.01×Pₗₐₛₑᵣ<P_{LED}<100×Pₗₐₛₑᵣ to obtain the sterilization and/or catalytic benefits of the invention.

The combined light, which includes the LED UV light, the laser UV light and, optionally, the unconverted laser light are used to treat a fluid, solid or a surface.

The fluid may be a liquid, which for example may be water. Alternatively the fluid may be a gas, which for example may be air. The fluid may be treated by the combined light while the fluid is flowing through a pipe or while it is retained in a containment vessel. The treatment of the fluid by the UV light may cause sterilization of bacteria, viruses, spores or other pathogens which are in the fluid. Therefore, a fluid which is unsafe for use because of a high concentration of active pathogens may be treated by the UV light source so that the fluid becomes safe to use because many or all of the pathogens have been sterilized. For example, water which is unsafe to drink may be made safe to drink through treatment by the combined light.

The combined light may also cause formation of catalytic molecules in the water. For example, hydroxyl molecules may be formed from water molecules (H₂O) or from hydrogen peroxide (H₂O₂) molecules, owing to the ionising nature of the combined light. These molecules can initiate photocatalytic reactions in the fluid. For example, these molecules can catalyze a series of reactions which decompose harmful organic compounds (e.g., petroleum or pesticide residues) into harmless chemicals.

The treatment of a surface or solid by UV light may cause sterilization of bacteria, viruses, spores or other pathogens which are on the surface or in the solid. For example, a surface which contains hazardous pathogens may be made safe to touch after it has been treated by the combined light.

Advantages of the invention include:

a) the invention provides a practical method for treating a fluid, solid or surface with UV light with wavelengths between 180 nm and 400 nm using only solid-state light sources;

b) the invention overcomes the disadvantages associated with UV lamps (for example, mercury lamps) such as slow warm-up time;

c) the effectiveness of sterilization of bacteria, viruses, spores and other pathogens is improved through the use of UV light with at least one wavelength which is greater than or equal to 180 nm and less than 250 nm and at least one wavelength which is greater than or equal to 250 nm and less than 400 nm. This use of two of more wavelengths in these ranges results in more effective sterilization of a single type of pathogen and also more effective sterilization of a mixture of different types of pathogens; and

d) the effectiveness of the UV treatment to initiate photocatalytic reactions is improved through the use of UV light with a wavelength shorter than 250 nm.

In accordance with the above features, an aspect of the invention is a light source for use in a treatment device for treating a fluid, solid or surface. The light source includes a light emitting diode (LED) that emits a first component of ultraviolet (UV) light, and a UV laser light source that emits a second component of UV light having a peak wavelength different from a peak wavelength of the first component of UV light. The first component of UV light and the second component of UV light are applied to treat the fluid, solid or surface.

Another aspect of the invention is treatment device for treating a fluid, solid or surface. The treatment device includes the described light source and at least one of a container containing a fluid to be treated, or a solid or surface to be treated. UV light from the light source is applied to treat the fluid, solid or surface.

Another aspect of the invention is a method of generating a treating UV light for use in treating a fluid, solid or surface. The method includes the steps of providing a light emitting diode (LED) that emits a first component of ultraviolet (UV) light, providing a UV laser light source that emits a second component of UV light having a peak wavelength different from a peak wavelength of the first component of UV light, and emitting a treating UV light including the first component of UV light and the second component of UV light. The treating UV light is applied to treat the fluid, solid or surface.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 is a graphical depiction of a plot of the relative effectiveness of different wavelengths of UV light to deactivate an E-coli bacterium.

FIG. 2 is a graphical depiction of a plot of the relative effectiveness of different wavelengths of UV light to deactivate an adenovirus (Ad2).

FIG. 3 is a graphical depiction of a plot of the relative absorption of different wavelengths of UV light by hydrogen peroxide.

FIG. 4 is a graphical depiction of a plot of the relative average output power of LEDs emitting UV light at different wavelengths. The vertical scale is a logarithmic scale.

FIG. 5 is a schematic diagram depicting an exemplary ultraviolet light source for treatment of a surface, fluid or solid.

FIG. 6 is a schematic diagram depicting an exemplary component configuration of an ultraviolet light source for treatment of a surface, fluid or solid according to an embodiment of the invention.

FIG. 7 is a graphical depiction of a plot of the spectrum of combined light from an ultraviolet light source of an exemplary embodiment of the current invention.

FIG. 8 is a graphical depiction of a first enlargement of the plot in FIG. 7

FIG. 9 is a graphical depiction of a second enlargement of the plot in FIG. 7

FIG. 10 is a schematic diagram depicting another exemplary component configuration of an ultraviolet light source for treatment of a surface, fluid or solid according to an embodiment of the invention.

FIG. 11 is a graphical depiction of a plot of the spectrum of combined light from an ultraviolet light source of an exemplary embodiment of the current invention.

FIG. 12 is a graphical depiction of a first enlargement of the plot in FIG. 11

FIG. 13 is a graphical depiction of a second enlargement of the plot in FIG. 11

FIG. 14 is a schematic diagram depicting another exemplary component configuration of an ultraviolet light source for treatment of a surface, fluid or solid according to an embodiment of the invention.

FIG. 15 is a graphical depiction of a plot of the spectrum of combined light from an ultraviolet light source of an exemplary embodiment of the current invention.

FIG. 16 is a graphical depiction of a first enlargement of the plot in FIG. 15

FIG. 17 is a graphical depiction of a second enlargement of the plot in FIG. 15

FIG. 18 is a schematic diagram depicting another exemplary component configuration of an ultraviolet light source for treatment of a surface, fluid or solid according to an embodiment of the invention.

FIG. 19 is a schematic diagram depicting another exemplary component configuration of an ultraviolet light source for treatment of a surface, fluid or solid according to an embodiment of the invention

FIG. 20 is a schematic diagram depicting another exemplary component configuration of an ultraviolet light source for treatment of a surface, fluid or solid according to an embodiment of the invention.

FIG. 21 is a schematic diagram depicting an exemplary component configuration of a device for treatment of a fluid by ultraviolet light

FIG. 22 is a schematic diagram depicting another exemplary component configuration of a device for treatment of a fluid by ultraviolet light.

FIG. 23 is a schematic diagram depicting another exemplary component configuration of a device for treatment of a fluid by ultraviolet light.

FIG. 24 is a schematic diagram depicting another exemplary component configuration of a device for treatment of a fluid by ultraviolet light.

FIG. 25 is a schematic diagram depicting another exemplary component configuration of a device for treatment of a fluid by ultraviolet light.

FIG. 26 is a schematic diagram depicting another exemplary component configuration of a device for treatment of a fluid by ultraviolet light.

FIG. 27 is a schematic diagram depicting another exemplary component configuration of a device for treatment of a surface by ultraviolet light.

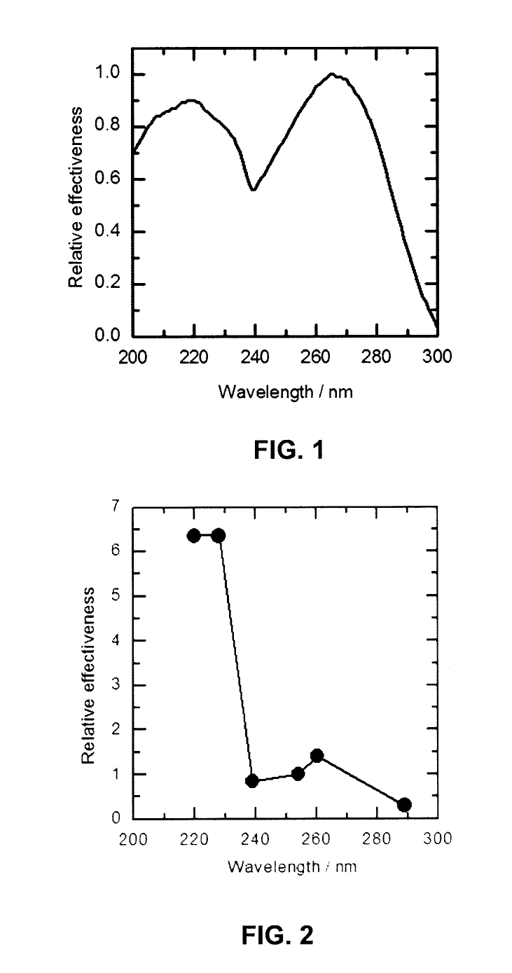

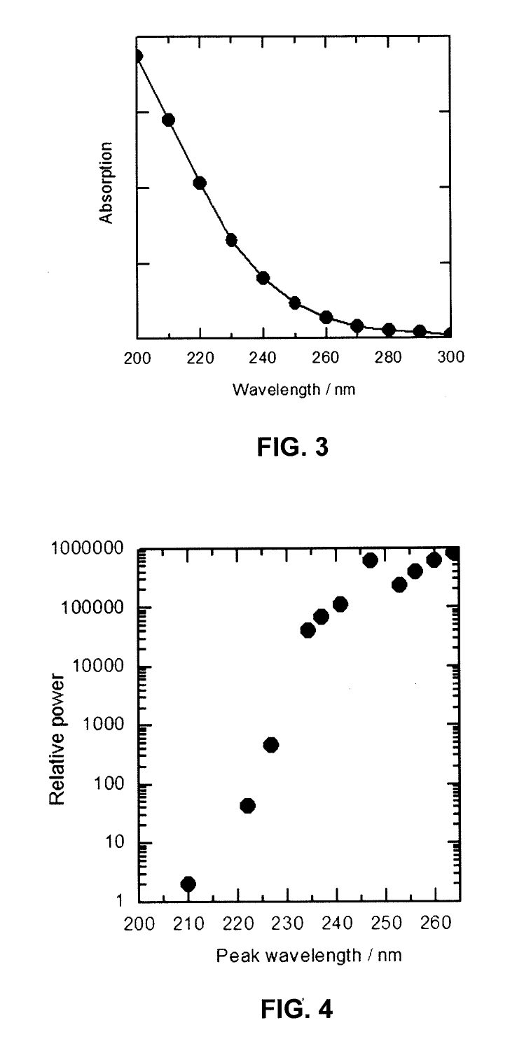

### DESCRIPTION OF REFERENCE NUMERALS

1. Ultraviolet (UV) light source

2. Light emitting diode(s) (LEDs)

3. UV light emitted by LED(s) 2

4. UV laser light source(s)

5. UV light emitted by UV laser light source(s) 4

6. Laser light source

7. Light emitted by laser light source 6

8. Frequency-doubling component

9. Unconverted laser light

10. Combined light

11. A fluid, solid or surface

17. Light emitting diode(s) (LEDs)

18. UV light emitted by LED(s) 17

19. UV laser light source(s)

20. UV light emitted by UV laser light source(s) 19

21. Laser diode

22. Light emitted by laser diode 21

23. Frequency-doubling component

24. Unconverted laser light

25. Filter

31. Second UV laser light source

32. Laser diode

33. Light emitted by laser diode 32

34. Frequency-doubling component

35. UV light emitted by UV laser light source(s) 31

36. Unconverted laser light

37. Filter

44. Light emitting diode(s)

45. UV light emitted by LEDs 44

46. UV laser light source

47. Laser light source

48. Light emitted by the laser light source 47

49. Frequency-doubling component

50. UV light emitted by UV laser light source 46

51. Unconverted light

52. Filter

60. Beam-combining element

61. Transparent pipe

62. Input fluid

63. Output fluid

68. Reflecting surface

69. Opening in the reflecting surface

70. Reflecting pipe

71. Inner surface of reflecting pipe

72. Window

79. Reflecting surface

80. First opening in the reflecting surface

81. First type of reflecting surface

82. Second opening in the reflecting surface

83. Second type of reflecting surface

89. First component to treat the fluid

90. Second component to treat the fluid

91. Containment vessel

92. First control valve

93. Retained fluid

94. Window

95. Mixing component

96. Second control valve

97. Surface

### DESCRIPTION OF EMBODIMENTS

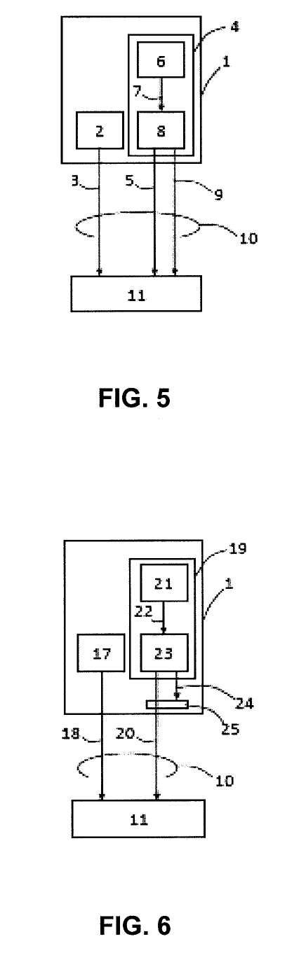

The present invention is a device for treatment of a fluid, surface or solid with ultraviolet (UV) light to provide sterilization and/or photocatalytic effects. FIG. 5 is a schematic diagram that depicts an exemplary embodiment of components of an ultraviolet (UV) light source 1. The UV light source 1 includes one or more light emitting diodes (LEDs) 2 emitting a first component of UV light 3 with a peak wavelength of approximately greater than or equal to 250 nm and less than or equal to 400 nm. The UV light source 1 further includes one or more UV laser light sources 4 emitting a second component of UV light 5. The UV laser light sources 4 include at least one laser light source 6 which emits light 7 with peak wavelength of approximately greater than or equal to 360 nm and less than 500 nm. The laser light source 6 may be a laser diode, a solid-state laser, a frequency-doubled laser or another suitable type of laser. The light 7 passes through a frequency-doubling component 8. As the light 7 passes through the frequency-doubling component 8, some or all of the light 7 is converted into UV light 5 by a second harmonic generation process. The second component of UV light 5, therefore, has a frequency which is approximately two times the frequency of the light 7 received by the frequency doubling component 8 from the laser light source 6 (equivalently, the wavelength of the UV light 5 is approximately half the wavelength of the light 7). The second component of UV light 5 thus has a peak wavelength which is determined by the wavelength of the light 7. Accordingly, the peak wavelength of the UV light 5 is approximately greater than or equal to 180 nm and less than 250 nm. Accordingly, the second component of UV light 5 has a peak wavelength different from the peak wavelength of the first component of UV light 3. As further explained below, the first component of UV light and the second component of UV light are applied to treat the fluid, solid or surface. Any of the light 7 which is not converted into UV light 5 may also be emitted from the frequency-doubling component 8 as unconverted laser light 9.

If the total power of UV light 5 emitted by the laser light source is denoted Pₗₐₛₑᵣ and the total power of UV light 3 emitted by the LED is denoted P_{LED}, then P_{LED} may be in the range of 0.01×Pₗₐₛₑᵣ<P_{LED}<100×Pₗₐₛₑᵣ to obtain the sterilization and/or photocatalytic benefits of the invention. To obtain the most benefits of the invention, the total power of UV light 3 emitted by the LED preferably is in the range 0.1×Pₗₐₛₑᵣ<P_{LED}<10×Pₗₐₛₑᵣ.

The combined light 10, which includes the UV light 3, the UV light 5 and, optionally, the unconverted laser light 9 are used to treat a fluid, solid or a surface 11.

The fluid may be a liquid, such as, for example, water. Alternatively the fluid may be a gas, such as, for example, air. The treatment of the fluid by the UV light may cause sterilization of bacteria, viruses, spores or other pathogens which are in the fluid. Sterilized viruses and bacteria are unable to function as normal and, in particular, are unable to reproduce. Therefore, a fluid which is unsafe for use because of a high concentration of active pathogens may be treated by the UV light source 1 so that the fluid becomes safe to use because a significant amount or all of the pathogens have been sterilized. For example, water which is unsafe to drink may be made safe to drink through treatment by the combined light 10.

The combined light 10 may also cause formation of catalytic molecules in the water. For example, hydroxyl molecules may be formed from water molecules (H₂O) or from hydrogen peroxide (H₂O₂) molecules, owing to the ionizing nature of the combined light 10. These molecules can initiate photocatalytic reactions in the fluid. For example, these molecules can catalyze a series of reactions which decompose harmful organic compounds (e.g. petroleum or pesticide residues) into harmless chemicals.

The treatment of a surface or solid by UV light may cause sterilization of bacteria, viruses, spores or other pathogens which are on the surface or in the solid. For example, a surface which contains hazardous pathogens may be made safe to touch after it has been treated by the combined light 10.

This invention offers significant advantages over conventional alternatives. In particular, the current invention provides an improved method to treat a surface using UV light with wavelengths approximately between 180 nm and 400 nm. The invention provides an entirely solid-state light source which can emit wavelengths approximately between 180 nm and 400 nm with high efficiency. This overcomes the disadvantages of UV lamps such as mercury lamps. For example, the slow “warm-up” time of mercury lamps is overcome because the solid-state UV light sources emit UV light instantaneously. Furthermore, the invention overcomes the problem of very poor performance of LEDs emitting wavelengths approximately of less than 250 nm. This poor performance of LEDs emitting wavelengths of less than 250 nm means that it is not practical to use UV light with wavelength less than 250 nm in a LED-based UV treatment device. The current invention improves over conventional LED-based treatment devices by providing emission of UV light with wavelength less than 250 nm with sufficient power to achieve sterilization and/or photocatalytic effects.

The use of two or more wavelengths in the range approximately between 180 nm and 400 nm, including at least one wavelength less than 250 nm and at least one wavelength higher than 250 nm, results in more effective sterilization of pathogens. In particular, more effective sterilization can be obtained for the same UV power than for use of UV light with a single wavelength or use of wavelengths only less than 250 nm or only greater than 250 nm. There are at least two advantages of this configuration of the current invention over conventional configurations. First, the sterilization of a single type of pathogen may be made more effective because different mechanisms to damage the pathogens are brought about by the different wavelengths of UV light. This leads to synergy of two or more UV wavelengths because the pathogen has weaker defence when it is damaged by two mechanisms in the same treatment. Second, the sterilization of a mixture of two or more types of pathogens may be made more effective than when a single wavelength of UV light is used because different pathogens are more susceptible to sterilization by different wavelengths of UV light. For example, viruses such as Adenoviruses are much more vulnerable to UV wavelengths shorter than 250 nm, whereas bacteria such as E-Coli are more vulnerable to UV wavelengths longer than 250 nm. This is significant in products which are designed for sterilization because there is the possibility that a fluid, solid or surface may be infected by an unknown mixture of many different types of pathogen.

### EXAMPLE 1

Another exemplary embodiment of an ultraviolet light source 1 for treatment of a fluid, solid or surface is depicted in the schematic diagram of FIG. 6. The light source includes one or more LEDs 17 emitting UV light 18 with a peak wavelength approximately greater than or equal to 250 nm and less than or equal to 400 nm. For example, the device contains a plurality of LEDs 17 emitting UV light 18 with a peak wavelength of approximately 265 nm. The LEDs 17 may include Al_{y}InₓGa_{1-x-y}N semiconductor materials (0<y<1; 0<x<1). The device further includes one or more UV laser light sources 19 emitting UV light 20. The laser light sources 19 include a laser diode 21 emitting light 22 with a peak wavelength approximately greater than or equal to 360 nm and less than 500 nm. The laser diode may include Al_{y}InₓGa_{1-x-y}N semiconductor materials (0<y<1; 0<x<1). In the example of this embodiment, the light 22 has a peak wavelength of approximately 442 nm. The light 22 passes through a frequency-doubling component 23. As the light 22 passes through the frequency-doubling component 23, some or all of the light 22 is converted into UV light 20 by a second harmonic generation process. If the light 22 has a peak wavelength of approximately 442 nm, then the UV light 20 has a peak wavelength of approximately 221 nm. The frequency doubling component 23 may include β-BaB₂O₄. β-BaB₂O₄ is a material which can provide high-efficiency second harmonic generation of incident light with wavelength between 410 nm and 500 nm.

The frequency-doubling component 23 may not convert all of the light 22 into UV light 20. Any of the light 22 which is not converted into UV light 20 may also be emitted from the frequency-doubling component 23 as unconverted laser light 24. Unconverted laser light 24 with peak wavelength of approximately 442 nm is blocked by a filter 25. The filter 25 transmits most or all of the UV light 20 but blocks most or all of the unconverted laser light 24.

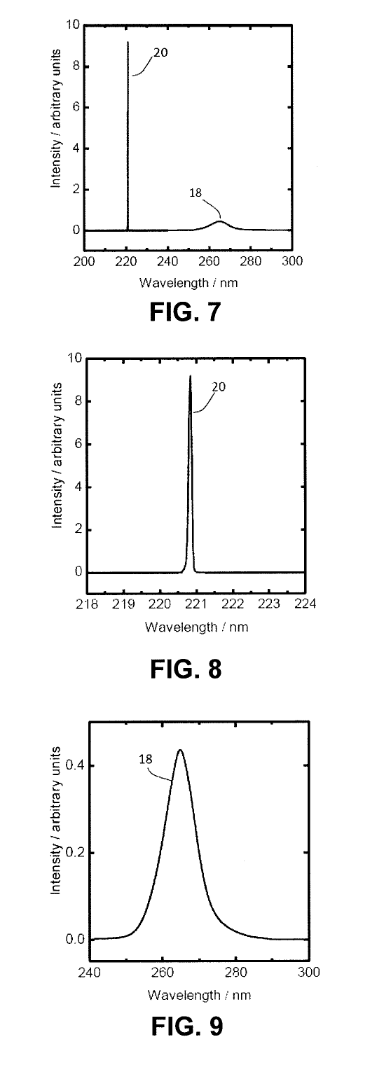

An example of the spectrum of the combined light 10 (which is the combination of the UV light 18 and the UV light 20) is plotted in the graphical diagram of FIG. 7. Enlargements of the data in this plot are shown in FIG. 8 and FIG. 9. The labels in FIGS. 7, 8 and 9 indicate the contributions to the spectrum from the UV light 20 with peak wavelength of approximately 221 nm and the UV light 18 with peak wavelength of approximately 265 nm. The enlargement in FIG. 8 shows the spectrum of the UV light 20 with peak wavelength of approximately 221 nm. The spectrum of light emitted by a laser diode typically has a wavelength full width at half maximum (FWHM) of less than 5 nm, so the wavelength of the frequency-doubled UV light 20 has a full width at half maximum of less than 2.5 nm. The enlargement in FIG. 9 shows the spectrum of UV light 18 with peak wavelength of approximately 265 nm. The spectrum of light emitted by an LED typically has a wavelength full width at half maximum of at least 10 nm.

If the total power of UV light 20 emitted by the laser light source is denoted Pₗₐₛₑᵣ and the total power of UV light 18 emitted by the LED is denoted P_{LED}, then P_{LED} may be in the range 0.01×Pₗₐₛₑᵣ<P_{LED}<100×Pₗₐₛₑᵣ to obtain the sterilization and/or photocatalytic benefits of the invention. To obtain particularly enhanced benefits of the invention, the total power of UV light 18 emitted by the LED is in the range 0.1×Pₗₐₛₑᵣ<P_{LED}<10×Pₗₐₛₑᵣ. For the example shown in FIG. 7, the total power of the UV light 18 emitted by the LED is approximately 5 times higher than the total power of the UV light 20 emitted by the laser light source (P_{LED}≈5×Pₗₐₛₑᵣ).

The combined light 10 is used to treat a fluid, solid or surface, 11.

A significant advantage of this embodiment is that it exploits the high performance of existing laser diodes with emission wavelengths approximately greater than or equal to 360 nm and less than 500 nm. These laser diodes usually include Al_{y}InₓGa_{1-x-y}N semiconductor materials (0<y<1; 0<x<1), and they are available with low cost and in very compact packages. A UV light source 19 fabricated according to the present invention emits UV light 20 with peak wavelength 221 nm with power of more than 1 mW using a laser diode 21 emitting a wavelength of 442 nm and a frequency-doubling component including a β-BaB₂O₄ crystal. The spectral data plotted in FIG. 7 and FIG. 8 was measured from this UV light source 19. This 1 mW output power is at least 200 times higher than the output power of conventional LEDs emitting UV light with wavelength between 180 nm and 230 nm. Further increases in power of the UV light 20 can be obtained by increases in the efficiency of the frequency-doubling component and in the output power of the laser diodes. This embodiment thus provides the possibility to have high output power solid-state UVC light sources emitting light in the wavelength range between 180 nm and 250 nm.

### EXAMPLE 2

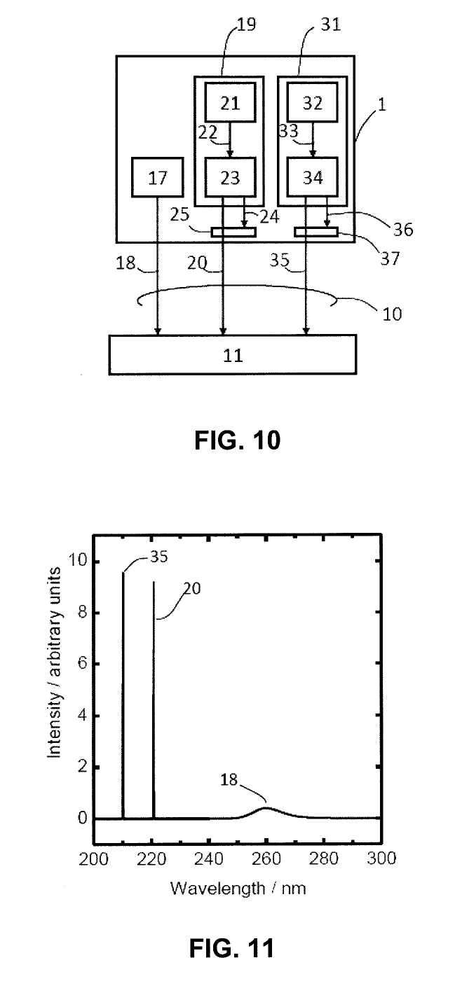

Another exemplary embodiment of an ultraviolet light source 1 for treatment of a fluid, solid or surface is depicted in the schematic diagram of FIG. 10. This embodiment is similar to the previous embodiment and the similar features will not be repeated in the description. The distribution of wavelengths of the combined light 10 are different in this embodiment of Example 2. The UV light source 1 includes one or more LEDs 17 emitting UV light 18 with a peak wavelength approximately greater than or equal to 250 nm and less than or equal to 400 nm. In this exemplary embodiment, the light source 1 contains a plurality of LEDs 17 emitting UV light 18 with a peak wavelength of approximately 260 nm. The device further includes a plurality of two or more laser light sources: at least one of a first UV laser light source 19 and at least one of a second UV laser light source 31. The first UV laser light source 19 includes a laser first diode 21 emitting light 22, and a first frequency-doubling component 23 which converts some or all of the light 22 into a first portion of the second component of UV light 20. The second UV laser light source 31 includes a laser diode 32 emitting light 33, and a second frequency-doubling component 34 which converts some or all of the light 33 into a second portion of the second component of UV light 35. The light 22 and the light 33 each have a different peak wavelength which is approximately greater than or equal to 360 nm and less than 500 nm. Therefore, the first portion of the second component of UV light 20 and the second portion of the second component of UV light 35 have different peak wavelengths which are each approximately greater than or equal to 180 nm and less than 250 nm. In this example, the at least one first UV laser light source 19 emits the first portion of the second component of UV light 20 with a peak wavelength of approximately 221 nm (i.e., the light 22 has peak wavelength of approximately 442 nm). The at least one second UV laser light source 31 emits the second portion of the second component of UV light 35 with a peak wavelength of approximately 211 nm (i.e., the light 33 has peak wavelength of approximately 422 nm). In other words, the first portion of the second component of UV light 20 has a frequency that is two times the frequency of the light received by the first frequency doubling component 23 from the first laser light source 21, and the second portion of the second component of UV light 35 has a frequency that is two times the frequency of the light received by the second frequency doubling component 34 from the second laser light source 32. Both frequency-doubling components 23 and 34 may include β-BaB₂O₄.

Any of the light 22 which is not converted by the frequency-doubling component 23 may be emitted as unconverted light 24, and is substantially blocked by a first filter 25. Any of the light 33 which is not converted by the frequency-doubling component 34 may be emitted as unconverted light 36 and is substantially blocked by a second filter 37.

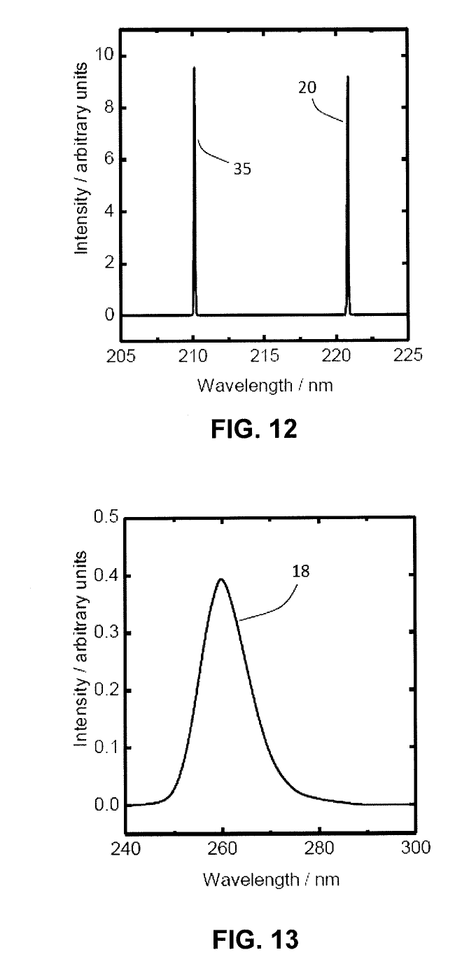

An example of the spectrum of the combined light 10 (which is the combination of the UV light 18, 20 and 35) is plotted in the graphical diagram of FIG. 11. Enlargements of the data in this plot are shown in FIG. 12 and FIG. 13. The labels in FIGS. 11, 12 and 13 indicate the contributions to the spectrum of the UV light 18, 20 and 35.

The combined light 10 is used to treat a fluid, solid or surface 11.

Compared with the first example, the use of light with a second wavelength that is shorter than 250 nm increases the effectiveness of the sterilization function of the device. The use of a shorter wavelength UV light (i.e., wavelength 211 nm) further can increase the efficiency of formation of catalytic molecules such as hydroxyl radicals.

### EXAMPLE 3

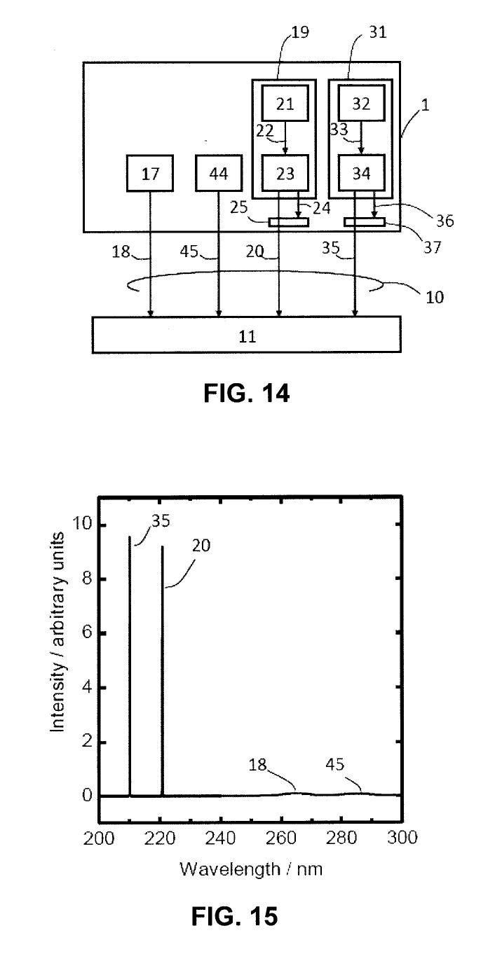

Another exemplary embodiment of an ultraviolet light source 1 for treatment of a fluid, solid or surface is depicted in the schematic diagram of FIG. 14. The embodiment of Example 3 is similar to the previous embodiments and the similar features will not be repeated in the description. The distribution of wavelengths of the combined light 10 is different in the embodiment of Example 3. The UV light source 1 contains a set of a plurality, and at least two or more, LEDs: at least one of a first type of LED 17 and at least one of a second type of LED 44. The first type of LED 17 emits a first portion of the first component of UV light 18. The second type of LED 44 emits a second portion of the first component of UV light 45. The peak wavelength of the first portion of the first component of UV light 18 and the second portion of the first component of UV light 45 are different and are each approximately greater than or equal to 250 nm and less than or equal to 400 nm. In this example, the UV light 18 has a peak wavelength of approximately 265 nm and the UV light 45 has a peak wavelength of approximately 285 nm.

Similarly to the previous embodiment, the light source 1 further includes two or more laser light sources: at least one of a first UV laser light source 19 and at least one of a second UV laser light source 31. The first UV laser light source 19 includes a laser diode 21 emitting light 22 and a first frequency-doubling component 23 which converts some or all of the light 22 into the first portion of the second component of UV light 20. The second UV laser light source 31 includes a laser diode 32 emitting light 33 and a second frequency-doubling component 34 which converts some or all of the light 33 into the second portion of the second component of UV light 35. The light 22 and the light 33 each have a different peak wavelength which is approximately greater than or equal to 360 nm and less than 500 nm. Therefore, the UV light 20 and the UV light 35 have different peak wavelengths which are each approximately greater than or equal to 180 nm and less than 250 nm. In this example, the at least one first UV laser light source 19 emits UV light 20 with a peak wavelength of approximately 221 nm (i.e., the light 22 has wavelength 442 nm). The at least one second UV laser light source 31 emits UV light 35 with a peak wavelength of approximately 211 nm (i.e., the light 33 has wavelength of 422 nm). Both frequency-doubling components 23 and 34 may include β-BaB₂O₄. Any of the light 22 which is not converted by the frequency-doubling component 23 may be emitted as unconverted light 24 and is substantially blocked by a filter 25. Any of the light 33 which is not converted by the frequency-doubling component 34 may be emitted as unconverted light 36 and is substantially blocked by a filter 37.

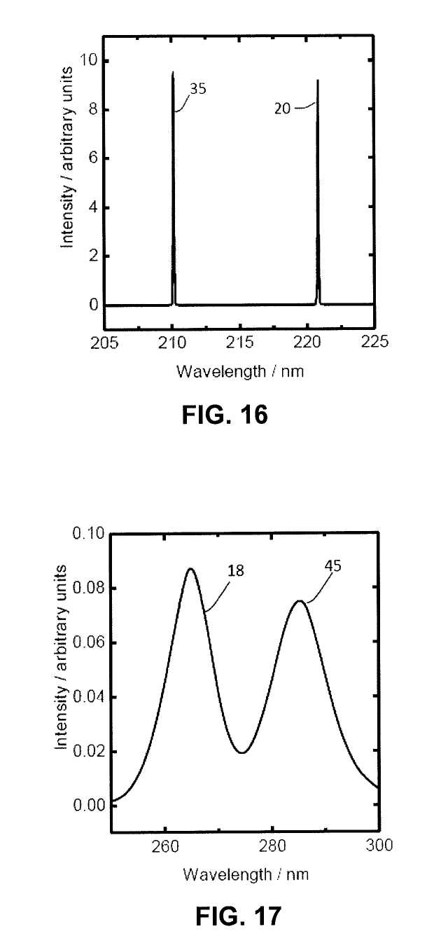

An example of the spectrum of the combined light 10 (which is the combination of the UV light 18, 20, 35 and 45) is plotted in graphical diagram of FIG. 15. Enlargements of the data in this plot are shown in FIG. 16 and FIG. 17. The labels in FIGS. 15, 16 and 17 indicate the contributions to the spectrum of the UV light 18, 20, 35 and 45.

The combined light 10 is used to treat a fluid, solid or surface 11.

Compared with the first and second examples, the use of light with wavelengths of approximately 211 nm, approximately 221 nm, approximately 265 nm and approximately 285 nm result increases the effectiveness of the sterilization function of the device.

### EXAMPLE 4

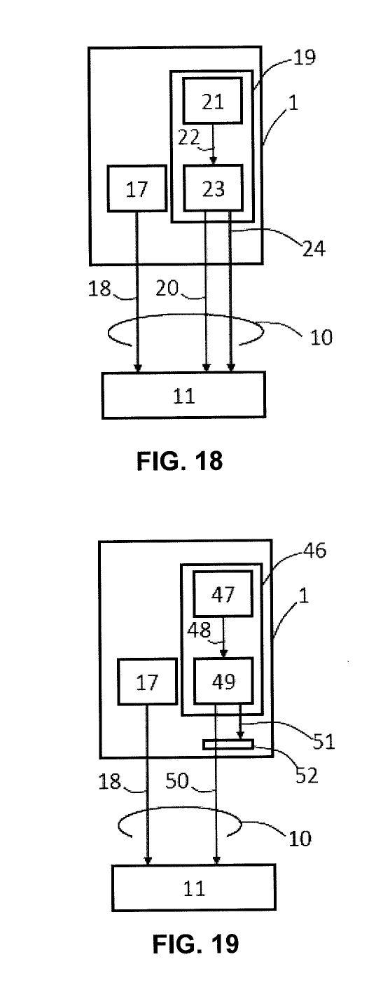

Another exemplary embodiment of an ultraviolet light source 1 for treatment of a fluid, solid or surface is depicted in the schematic diagram of FIG. 18. The embodiment of Example 4 is similar to the previous embodiments and the similar features will not be repeated in the description.

The light source 1 includes one or more LEDs 17 emitting UV light 18 with a peak wavelength approximately greater than or equal to 250 nm and less than or equal to 400 nm. In this example, the light source 1 contains a plurality of LEDs 17 emitting light 18 with a peak wavelength of approximately 265 nm. The LEDs may include Al_{y}InₓGa_{1-x-y}N semiconductor materials. The light source further includes one or more laser light sources 19 emitting UV light 20. The laser light sources 19 include a laser diode 21 emitting light 22 with a peak wavelength approximately greater than or equal to 360 nm and less than 500 nm. In this example, the light 22 has a peak wavelength of approximately 442 nm. The light 22 passes through a frequency-doubling component 23. As the light 22 passes through the frequency-doubling component 23, some of the light 22 is converted into UV light 20 by a second harmonic generation process. If the light 22 has a peak wavelength of approximately 442 nm, then the UV light 20 has a peak wavelength of approximately 221 nm. The frequency doubling component 23 may include β-BaB₂O₄. The frequency-doubling component 23 does not convert all of the light 22 into UV light 20. The light 22 which is not converted into UV light 20 exits the frequency-doubling component as unconverted light 24. The unconverted light 24 has similar peak wavelength as the light 22. Unlike the previous embodiments, the unconverted light 24 is not filtered from the UV light 20.

The combined light 10 (which is the combination of the light 24 and the UV light 18 and 20) is used to treat a fluid, solid or surface 11.

Compared with the previous examples, the additional use of the unconverted light 24 in the treatment of the fluid, solid or surface may increase the effectiveness of the sterilization or catalytic function of the device. Whether or not a filter is employed to block the unconverted light may depend upon the sterilization application.

The unconverted light 24 can cause sterilization of pathogens, which is complementary to the sterilizing effect of the first UV light and the second UV light. Thus, including the unconverted light 24 in the combined light 10 can increase the overall effectiveness of the sterilization in certain circumstances. This can especially be the case when the unconverted light 24 has a wavelength shorter than approximately 420 nm. The unconverted light 24 can cause catalytic function that is complementary to the catalytic function of the first UV light and the second UV light. Thus, including the unconverted light 24 in the combined light 10 can increase the overall effectiveness of the catalytic function.

Many bacteria, viruses and spores, however, have mechanisms to repair damage caused by treatment with UVC light. For example, bacteria, viruses and spores can repair sections of their DNA which have been damaged by UVC light. These repair mechanisms in the bacteria, viruses and spores can be made more effective if the bacteria, viruses and spores are exposed to some types of visible light. This recovery phenomenon is known as “photo-reactivation”. If the repair mechanisms are made more effective, then a higher fluence of UVC light is required in the first place to irreparably sterilize the bacteria, viruses or spores—that is to sterilize the bacteria, viruses or spores so that they cannot repair the damage and become able to reproduce again.

In applications which require sterilization of these pathogens, it may be advantageous to reduce the exposure of the pathogens to visible light after they have been treated by UVC light because this reduces the enhancement of the repair mechanisms. In these cases it may be advantageous to prevent some or all of the unconverted light 24 from reaching the pathogens, and the embodiments of Examples 1-3 (FIGS. 6, 10, and 14), which include filters 25 or 37, may be more suitable systems.

### EXAMPLE 5

Another exemplary embodiment of an ultraviolet light source 1 for treatment of a fluid, solid or surface is depicted in the schematic diagram of FIG. 19. The embodiment of Example 5 is similar to the previous embodiments and the similar features will not be repeated in the description. The light source 1 includes one or more LEDs 17 emitting UV light 18 with a peak wavelength approximately greater than or equal to 250 nm and less than or equal to 400 nm. In this example, the light source contains a plurality of LEDs 17 emitting light 18 with a peak wavelength of approximately 260 nm. The light source 1 further includes one or more laser light sources 46 emitting UV light. The laser light source 46 includes a laser light source 47 emitting light 48 with a peak wavelength approximately greater than or equal to 360 nm and less than 500 nm. For example, the laser light source 47 may emit light 48 with peak wavelength of approximately 473 nm. Laser light sources which emit light with wavelength 473 nm are known. For example, laser light sources which emit 473 nm can be fabricated using a laser diode, a neodymium-doped yttrium aluminum garnet (Nd:Y₃Al₅O₁₂; commonly referred to as “Nd:YAG”) and a frequency-doubling component.

The light 48 passes through a frequency-doubling component 49. As the light 48 passes through the frequency-doubling component 49, some or all of the light 48 is converted into UV light 50 by a second harmonic generation process. If the light 48 has a peak wavelength of approximately 473 nm, then the UV light 50 has a peak wavelength of approximately 236.5 nm. The frequency doubling component 49 may include β-BaB₂O₄. The frequency-doubling component 49 may be located within the laser cavity of the laser light source 47. The frequency-doubling component 49 may not convert all of the light 48 into UV light 50. Any of the light 48 which is not converted by the frequency-doubling component 49 may be emitted as unconverted light 51 and is substantially blocked by a filter 52.

The combined light 10 (which is the combination of the UV light 18 and 50) is used to treat a fluid, solid or surface 11.

Compared with the previous examples, the use of a laser light source 47 increases the power of the UV light 50 and provide wavelengths of light 48 (and hence wavelengths of UV light 50) which are difficult to achieve using conventional laser diodes, and this increases the effectiveness of the sterilization function of the device.

### EXAMPLE 6

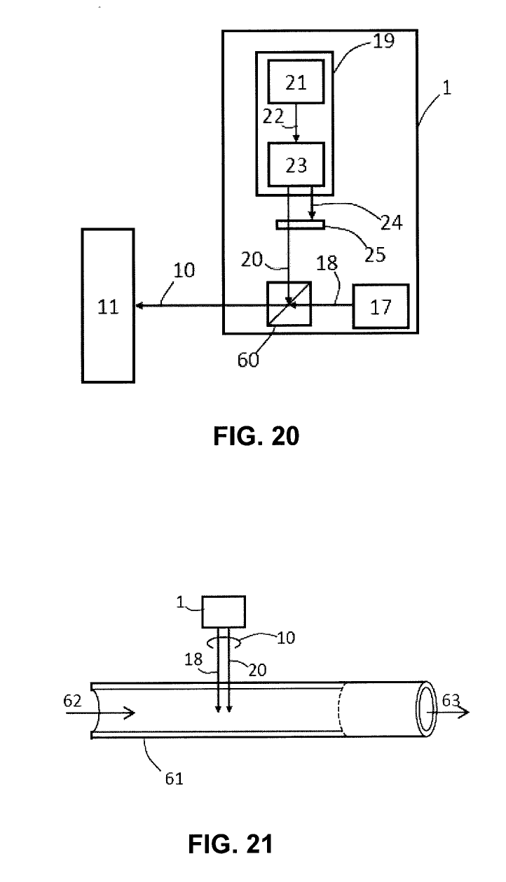

Another exemplary embodiment of an ultraviolet light source 1 for treatment of a fluid, solid or surface is depicted in the schematic diagram of FIG. 20. The embodiment of Example 6 is similar to previous embodiments and the similar features will not be repeated in the description.

The UV light source 1 further includes a beam-combining element 60 which ensures that there is high spatial overlap between the first component of UV light 18 and the second component of UV light 20 in the combined light 10. In other words, the beam combining element 60 spatially overlaps the first component of UV light 18 and the second component of UV light 20 to generate a combined UV light 10 that is emitted from the light source at a common location.

One example of a suitable beam-combining element is a dichroic mirror which is highly reflective to the UV light 20 and highly transmissive to the UV light 18.

The combined light 10 (which is the combination of the UV light 18 and 20) is used to treat a fluid, solid or surface 11.

An advantage of this embodiment is that the UV light 20 and UV light 18 are delivered to essentially the same location at the fluid, solid or surface 11 which, ensures that all wavelengths in the combined light 10 are able to treat the fluid, solid or surface 11 at the same time and at a common location.

In accordance with the above embodiments, a method of generating a treating UV light for use in treating a fluid, solid or surface may include the steps of: providing a light emitting diode (LED) that emits a first component of ultraviolet (UV) light; providing a UV laser light source that emits a second component of UV light having a peak wavelength different from a peak wavelength of the first component of UV light; and emitting a treating UV light including the first component of UV light and the second component of UV light. In turn, a method of treating a fluid, solid or surface may include the steps of: generating the described treating UV light; providing at least one of a container containing a fluid to be treated, or a solid or surface to be treated; and treating the fluid, solid or surface by applying the treating UV light to the fluid, solid or surface. Treating the fluid, solid or surface may include at least one of sterilizing the fluid, solid or surface, or forming photocatalytic molecules in the fluid or on the solid or surface.

Any of the above exemplary embodiments of the light source may be incorporated into a treatment device for treating a fluid, solid or surface. Exemplary embodiments of a treatment device for treating a fluid, solid or surface include a light source in accordance with any of the above embodiments, and at least one of a container containing a fluid to be treated, or a solid or surface to be treated. The following describes examples of treatments devices that may utilize the described light sources.

### EXAMPLE 7

FIG. 21 is a schematic diagram depicting an exemplary embodiment of a device for treatment of a fluid. The treatment device uses a UV light source 1, for example as described in Example 1 above. Alternatively, the UV light sources described in Examples 2 through 6 could be used as the UV light source 1. The combined light 10 (a combination of the UV light 18 and 20) is used to treat the fluid as it flows through a transparent pipe 61, which is the fluid container in this embodiment. The illustration in FIG. 21 shows a cross-section through the pipe. The transparent pipe 61 is substantially transparent to the UV light 18 and the UV light 20. Suitable materials for the transparent pipe 61 include, for example, UV fused silica and fluoropolymer materials (or comparable UV transparent materials).

Fluid flows through the pipe in the direction indicated by the arrows at 62 and 63. The input fluid 62 may include bacteria, viruses, spores or other pathogens. The combined light 10 causes sterilization of the bacteria, viruses, spores or other pathogens which are in the fluid. Sterilized viruses and bacteria are unable to function as normal and in particular are unable to reproduce. Owing to the sterilizing effect of the combined light 10, the output fluid 63 contains fewer harmful bacteria, viruses or other pathogens than the input fluid 62.

The combined light 10 may also cause formation of catalytic molecules in the fluid. In one example the fluid is water. The input water 62 may not be safe for use, and the water is made safe for use through the sterilizing effect of the UV light. For example, although the input water 62 may not be safe for drinking, the water is made safe for drinking. The fluence of the combined light 10 in the water should be sufficient to sterilize pathogens in the input water 62 so that the output water 63 is safe for use. In exemplary embodiments, the total fluence of UV light into the water is at least 20 mJcm⁻². The total power of the UV light X depends on the speed of the water flow along the transparent pipe 61 and should be calculated accordingly. As an example, for a water flow rate of approximately 30 cm³ per second, the preferred total power of UV light is at least 100 mW.

The UV light may also cause formation of catalytic molecules in the water. For example, hydroxyl molecules may be formed from water molecules (H₂O) or from hydrogen peroxide (H₂O₂) molecules, owing to the ionizing nature of the combined light 10.

In another example the fluid is air. The input air 62 may contain a hazardous concentration of airborne pathogens. Owing to the sterilizing effect of combined light 10, the output air 63 contains fewer harmful bacteria, viruses, spores or other pathogens than the input air 62. The fluence of the combined light 10 in the air should be sufficient to sterilize the pathogens that are in the air. In exemplary embodiments, the total fluence of UV light into the air is at least 10 mJcm⁻².

### EXAMPLE 8

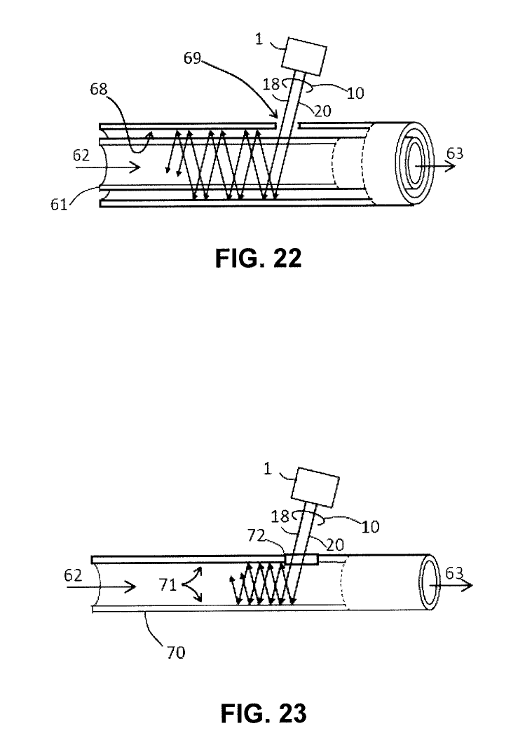

Another exemplary embodiment of a treatment device for treatment of a fluid is depicted in the schematic diagram of FIG. 22. The embodiment of Example 8 is similar to that of Example 7 in that a pipe is the fluid container, and the similar features will not be repeated in the description. The embodiment of Example 8 further includes a reflecting surface 68 located around at least a portion of the external surface of the transparent pipe 61. The reflecting surface has a high reflectivity for at least one of UV light 18 and UV light 20. Preferably the reflecting surface has a high reflectivity of both the UV light 18 and 20. For example, the reflecting surface 68 may have a reflectivity of at least 90% for UV light 18 and 20, and may have a reflectivity of at least 99% for UV light 18 and 20. Suitable materials for the reflecting surface 68 include, for example, aluminium, aluminium-based alloys or stainless steel. The reflecting surface 68 may include a coating of one of more layers which increase the reflectivity for UV light 18 and/or UV light 20. Suitable materials for coating layers include, for example, MgF₂ and LaF₃. Although the illustration in FIG. 22 shows a space between the transparent pipe 61 and the reflecting surface 68, the reflecting surface 68 may be in direct contact with the external surface of the transparent pipe 61. Also, the reflecting surface 68 may be a coating which is applied to the external surface of the transparent pipe 61.

The combined light 10 passes through an opening in the reflecting surface 69, and may pass at an angle so as to permit repeated reflection multiple times by the reflecting surface 68. The reflecting surface 68 allows combined light 10 which passes through the pipe and the fluid for a first time to pass through the pipe and fluid for at least a second time, as indicated by the arrows in FIG. 22. This increases the effectiveness of the UV light in treating of the fluid, and permits the initial power of the combined light 10 to be lowered while achieving the same treatment effectiveness.

Although the illustration in FIG. 22 indicates a round cross-section for the pipe and the reflecting surface, either or both of the pipe and the reflecting surface may have alternatively shaped cross-sections. For example, the pipe and the reflecting surface may have a rectangular cross-section. The use of a pipe and reflecting surface with rectangular cross-section can result in higher reflectivity of the UV light 18 and the UV light 20 because the angle of incidence of the light at the reflecting surface remains similar for several reflections.

### EXAMPLE 9

Another exemplary embodiment of a treatment device for treatment of a fluid is depicted in the schematic diagram of FIG. 23. Similarly to previous examples of a treatment device, the device includes a UV light source 1 as described, for example, in Example 1. Alternatively, the UV light sources described in Examples 2 through 6 could be used as the UV light source 1. The combined light 10 is used to treat the fluid as it flows through a reflecting pipe 70. The illustration in FIG. 23 shows a cross-section through the pipe. The inner surface 71 of the reflecting pipe 70—that is the surface which the fluid is in contact with—has a high reflectivity for at least one of the UV light 18 and UV light 20. Suitable materials for the inner surface of the pipe include, for example, aluminium, aluminium-based alloys and stainless steel. The inner surface 71 of the pipe may be polished or otherwise treated so that it has a high reflectivity for at least one of the UV light 18 and UV light 20. The inner surface 71 of the pipe may also include a coating of one of more layers which increase the reflectivity for UV light 18 and/or UV light 20. Suitable materials for coating layers include, for example, MgF₂ and LaF₃.

A window 72 is included in the wall of the reflecting pipe 70. The window 72 is highly transmissive for UV light 18 and 20. For example, the window 72 may have a transmission of more than 80% for UV light 18 and 20, and may have a transmission of more than 90% for UV light 18 and 20. Suitable materials for the window 73 include, for example, UV fused silica and fluoropolymers, and other suitable UV-transparent materials. The combined light 10 passes through the window 72, and may pass at an angle so as to permit repeated reflection by the reflecting surface 71. The reflecting inner surface 71 allows combined light 10 which passes through the fluid for a first time to pass through the pipe and fluid for at least a second time as indicated by the arrows in FIG. 23. This increases the effectiveness of the UV light in treating of the fluid and permits the initial power of the combined light 10 to be lowered while achieving the same treatment effectiveness.

Although the illustration in FIG. 23 indicates a round cross-section for the pipe and the reflecting surface, either or both of the pipe and the reflecting surface may have alternative shaped cross-sections. For example, the pipe and the reflecting surface may have a rectangular cross-section. The use of a pipe and reflecting surface with rectangular cross-section can result in higher reflectivity of the UV light 18 and 20 because the angle of incidence of the light at the reflecting surface remains similar for several reflections.

Fluid flows through the pipe in the direction indicated by the arrows at 62 and 63. The input fluid 62 may include bacteria, viruses, spores or other pathogens. The combined light 10 causes sterilization of the bacteria, viruses, spores or other pathogens which are in the fluid. Sterilized viruses and bacteria are unable to function as normal and in particular are unable to reproduce. Owing to the sterilizing effect of the combined light 10, the output fluid 63 contains fewer harmful bacteria, viruses or other pathogens than the input fluid 62.

The combined light 10 may also cause formation of catalytic molecules in the fluid.

In one example the fluid is water. The input water 62 may not be safe for use, and the water is made safe for use through the sterilizing effect of the UV light. For example, although the input water 62 may not be safe for drinking, the water is made safe for drinking. The fluence of the combined light 10 in the water should be sufficient to sterilize pathogens in the input water 62 so that the exit water 63 is safe for use. In exemplary embodiments, the total fluence of UV light into the water is at least 20 mJcm⁻². The total power of the combined light 10 depends on the speed of the water flow along the reflecting pipe 70 and should be calculated accordingly. As an example, for a water flow rate of approximately 30 cm³ per second, the preferred total power of UV light is at least 100 mW.

The UV light may also cause formation of catalytic molecules in the water. For example, hydroxyl molecules may be formed from water molecules (H₂O) or from hydrogen peroxide (H₂O₂) molecules, owing to the ionising nature of the combined light 10.

In another example the fluid is air. The input air 62 may contain a hazardous concentration of airbourne pathogens. Owing to the sterilizing effect of the combined light 10, the output air 63 contains fewer harmful bacteria, viruses, spores or other pathogens than the input air 62. The fluence of the combined light 10 in the air should be sufficient to sterilize the pathogens that are in the air. In exemplary embodiments, the total fluence of UV light into the air is at least 10 mJcm⁻².

### EXAMPLE 10

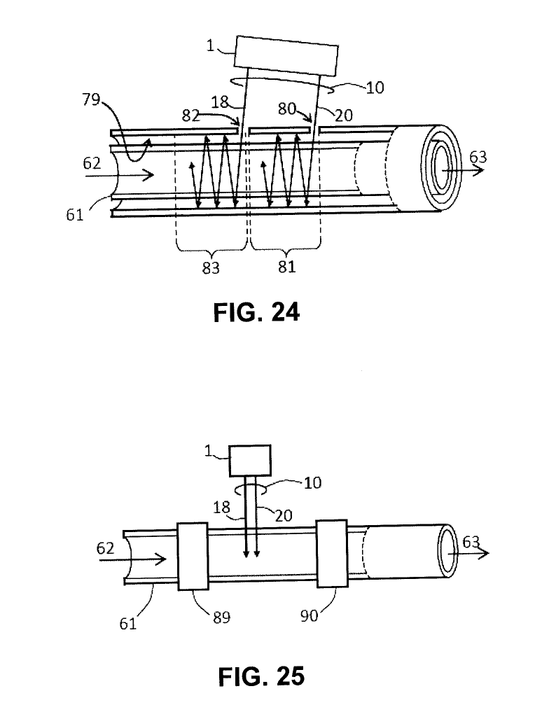

Another exemplary embodiment of a treatment device for treatment of a fluid is depicted in the schematic diagram of FIG. 24. The embodiment of Example 10 is similar to previous embodiments in that a pipe is the fluid container, and the similar features will not be repeated in the description. In this embodiment, a reflecting surface 79 is located around at least some of the external surface of the transparent pipe 61. The UV light 20 passes through a first opening in the reflecting surface 80, and may pass at an angle so as to permit repeated reflection by the reflecting surface 79. After passing through the pipe 61 and fluid, the UV light 20 is reflected at a first type of reflecting surface. The first type of reflecting surface is indicated by the region 81 in FIG. 24. The UV light 20 may thus be reflected several times at the first type of reflecting surface as indicated by the arrows in FIG. 24. The first type of reflecting surface has a high reflectivity for UV light 20. For example, the first type of reflecting surface may have a reflectivity of at least 90% for UV light 20, and may have a reflectivity of at least 99% for UV light 20.

The UV light 18 passes through a second opening 82 in the reflecting surface 79. This may be the same as the first opening in the reflecting surface 80 or it may be a different opening. After passing through the transparent pipe 61 and the fluid, the UV light 18 is reflected at a second type of reflecting surface. The second type of reflecting surface is indicated by the region 83 in FIG. 24. The UV light 18 may be reflected several times at the second type of reflecting surface as indicated by the arrows in FIG. 24. The second type of reflecting surface has a high reflectivity for UV light 18. For example the second type of reflecting surface may have a reflectivity of at least 90% for UV light 18, and may have a reflectivity of at least 99% for UV light 18.

Suitable materials for the first and second reflecting surfaces include, for example, aluminium, aluminium-based alloys or stainless steel. The first reflecting surface may include a coating of one of more layers which increase the reflectivity for UV light 20. The second reflecting surface may include a coating of one of more layers which increase the reflectivity for UV light 18. Suitable materials for coating layers include, for example, MgF₂ and LaF₃.

The use of first and second reflecting surfaces increases the effectiveness of the UV light in treating of the fluid, and permits the initial power of the UV light 18 and the UV light 20 to be lowered while achieving the same treatment effectiveness.

Although the illustration in FIG. 24 indicates a round cross-section for the pipe and the reflecting surface, either or both of the pipe and the reflecting surface may have alternative shaped cross-sections. For example, the pipe and the reflecting surface may have a rectangular cross-section. The use of a pipe and reflecting surface with rectangular cross-section can result in higher reflectivity of the UV light 18 and the UV light 20 because the angle of incidence of the light at the reflecting surface remains similar for several reflections.

### EXAMPLE 11

Another exemplary embodiment of a treatment device for treatment of a fluid is depicted in the schematic diagram of FIG. 25. The embodiment of Example 11 is similar to previous embodiments in that a pipe is the fluid container, and the similar features will not be repeated in the description.

The treatment device includes at least one component which treats the fluid. There may be one or more first component 89 to treat the fluid, which treats the fluid before it is exposed to combined light 10. There also may be one or more second components 90 to treat the fluid, which treats the fluid after it is exposed to UV light 10. There may be both one or more first components 89 and one or more second components 90, or there may be only one or more first component 89 or there may be only one or more second component 90.

In an example in which the fluid is water, a filter which reduces the concentration of ions in the water may be used as one of the first components 89 or one of the second components 90 to treat the fluid. For example, the first component to treat the fluid 89 may include an ion-exchange filter. It can be advantageous for the first component 89 to include a filter which removes ions from the water because removing ions from the water increases the transmission of UV light 18 and/or UV light 20 through the water, and thereby improves the effectiveness of the treatment of the water. In another example, the first or second component to treat the fluid 89, 90 may include a filter to remove particles from the fluid. In another example, the first component 89 or second component 90 may include an activated carbon filter. In another embodiment, the first component 89 includes an ion-exchange filter and the second component 90 includes an activated carbon filter.

In an example in which the fluid is air, the first component to treat the fluid 89 or the second component to treat the fluid 90 may include a particulate filter, such as a high-efficiency particulate air (HEPA) filter. Also, the first component 89 or second component 90 may include a high-voltage ion generator or an electrostatic ion generator. In another embodiment, the first component 89 may include a high-voltage ion generator.

The use of first component to treat the fluid 89 and/or second component to treat the fluid 90 increases the effectiveness of the treatment of the fluid as compared with the treatment only by the combined light 10.

### EXAMPLE 12

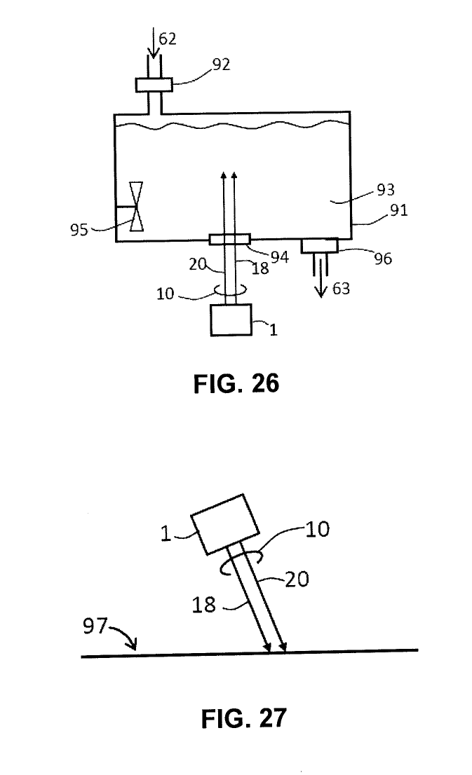

Another exemplary embodiment of a treatment device for treatment of a fluid is depicted in the schematic diagram of FIG. 26. Similarly to previous embodiments, the treatment device of Example 12 includes, for example, a UV light source 1 as described in the embodiment of Example 1. Alternatively, for example, the UV light sources described in Examples 2 through 6 could be used as the UV light source 1. FIG. 26 shows an illustration of a cross-section of a containment vessel 91. Input fluid 62 is added to the containment vessel 91 through a first control valve 92. The fluid is retained in the containment vessel 91. This retained fluid 93 is treated by combined light 10 emitted from the UV light source 1. The combined light 10 passes through a window 94 which has high transparency to the light. UV fused silica, for example is a suitable material for the window 94, although other suitable UV-transparent materials may be used. The inner surface of the containment vessel 91 (that is, the surface in contact with the retained fluid 93) may be highly reflecting to the UV light 18 and 20. Suitable materials for the containment vessel 91 include, for example, aluminium, aluminium-based alloys and stainless steel. The containment vessel may include a mixing component 95 which causes currents to form in the fluid so that there is uniform exposure of the fluid to the combined light 10. For example, the mixing component 95 may be an impellor.

The input fluid 62 may include bacteria, viruses, spores or other pathogens. The combined light 10 causes sterilization of the bacteria, viruses, spores or other pathogens which are in the fluid. Sterilized viruses and bacteria are unable to function as normal, and in particular are unable to reproduce. Once the action of the UV light has been sufficient to reduce the number of active pathogens (that is, pathogens which have not been sterilized) to an acceptable level, the fluid is extracted through a second control valve 96, and the exit fluid 63 may be used. Owing to the sterilizing effect of the combined light 10, the output fluid 63 contains fewer harmful bacteria, viruses or other pathogens than the input fluid 62. The combined light 10 may also cause formation of catalytic molecules in the fluid.

In one example the fluid is water. The input water 62 may not be safe for use, and the water is made safe for use through the sterilizing effect of the UV light. For example, although the input water 62 may not be safe for drinking, the water is made safe for drinking. The fluence of the combined light 10 in the water should be sufficient to sterilize pathogens in the retained water 93 so that the exit water 63 is safe for use. In exemplary embodiments, the total fluence of UV light into the water is at least 20 mJcm⁻². The total power of the combined light 10 depends on the volume of retained water 93 and the treatment time (that is, the time that the batch of water is exposed to the combined light 10). As an example, for a batch of 40,000 cm³ of water and a 12 hour treatment time, the preferred total power of UV light is at least 10 mW. The UV light may also cause formation of catalytic molecules in the water. For example, hydroxyl molecules may be formed from water molecules (H₂O) or from hydrogen peroxide (H₂O₂) molecules, owing to the ionising nature of the combined light 10.

In another example the fluid is air. The input air 62 may contain a hazardous concentration of airbourne pathogens. The retained air 93 may be held at pressure greater than atmospheric pressure during the treatment by the combined light 10. Owing to the sterilizing effect of the combined light 10, the output air 63 contains fewer harmful bacteria, viruses, spores or other pathogens than the input air 62. The fluence of the combined UV light 10 in the air should be sufficient to sterilise the pathogens that are in the air. In exemplary embodiments, the total fluence of UV light into the air is at least 10 mJcm⁻².

### EXAMPLE 13

FIG. 27 is a schematic diagram depicting an exemplary embodiment of a device for treatment of a surface. The device, for example, includes a UV light source 1 as described in the embodiment of Example 1. Alternatively, for example, the UV light sources described in Examples 2 through 6 could be used as the UV light source 1. The combined light 10 emitted by the UV light source 1 is used to irradiate a surface 97. There may be bacteria, viruses, spores or other pathogens on the surface 97. The combined light 10 causes sterilization of at least some of the bacteria, viruses, spores or other pathogens which are on the surface 97.

The total power of combined light 10 depends on the area of the surface and the treatment time (that is, the time during which the surface is irradiated with the combined light 10). For example, a fluence of combined light 10 of at least 5 mJcm⁻² is suitable for effective sterilization of pathogens on a surface. As an example, for a surface with area 100 cm² to be effectively sterilized in 10 seconds, the preferred total power of combined light 10 is at least 50 mW.

The combined light 10 may be addressed onto the surface in various ways. In a first example, the combined light 10 is distributed using lenses, mirrors or other optical components so the UV light is spread to irradiate the whole area of the surface 97. It is preferred that the power density of combined light 10 does not vary significantly within the area of the irradiated region, and that the ratio of powers between the UV light 18 and the UV light 20 does not vary significantly within the area of the irradiated region.

In another example, the combined light 10 may irradiate an area which is smaller than the entire area of the surface 97. In this case either the UV light source 1 is moved relative to the surface 97 during the treatment time, or the surface is moved relative to the UV light source 1, or the direction of the combined light 10 is moved relative to the surface 97 such that the whole of the surface 97 is irradiated with sufficient fluence of the combined light 10.

Examples 1-6 above are various configurations of exemplary lights sources for use in a device for treating a fluid, solid or surface. Examples 7-13 are various configurations of exemplary treatment devices. It will be appreciated that any exemplary light source configuration may be incorporated into any suitable treatment device. In other words, a given light source configuration is not limited for use in any particular treatment device configuration, and vice versa.

In accordance with the above features, an aspect of the invention is a light source for use in a treatment device for treating a fluid, solid or surface. The light source includes a light emitting diode (LED) that emits a first component of ultraviolet (UV) light, and a UV laser light source that emits a second component of UV light having a peak wavelength different from a peak wavelength of the first component of UV light. The first component of UV light and the second component of UV light are applied to treat the fluid, solid or surface.

In an exemplary embodiment of the light source, the peak wavelength of the first component of UV light is greater than or equal to 250 nm and less than or equal to 400 nm.

In an exemplary embodiment of the light source, the peak wavelength of the second component of UV light is greater than or equal to 180 nm and less than 250 nm.

In an exemplary embodiment of the light source, the UV laser light source includes a laser light source, and a frequency doubling component that receives light from the laser light source and converts the light into the second component of UV light. The second component of UV light has a frequency that is two times the frequency of the light received by the frequency doubling component from the laser light source, and the frequency doubling component does not convert a portion of the laser light from the laser light source and emits the portion of the light that is not converted as unconverted light.

In an exemplary embodiment of the light source, the laser light source includes a laser diode.

In an exemplary embodiment of the light source, the light source further includes a filter that blocks at least a portion of the unconverted light.

In an exemplary embodiment of the light source, the UV laser light source comprises a plurality of UV laser light sources, wherein each UV laser light source emits a component of UV light having a peak wavelength different from a peak wavelength of the first component of UV light.

In an exemplary embodiment of the light source, the plurality of UV laser light sources includes a first UV laser light sources that emits a first portion of the second component of UV laser light, and a second UV laser light source that emits a second portion of the second component of UV laser light having a peak wavelength different from the peak wavelengths of the first portion of the second component of UV light.

In an exemplary embodiment of the light source, the peak wavelength of the first component of UV light is greater than or equal to 250 nm and less than or equal to 400 nm.

In an exemplary embodiment of the light source, each of the peak wavelengths of the first and second portions of the second component of UV light is greater than or equal to 180 nm and less than 250 nm.

In an exemplary embodiment of the light source, the first and second of UV laser light source respectively includes first and second laser light sources, and first and second frequency doubling components that receive light respectively from the first and second laser light sources. The first frequency doubling component converts the light from the first laser light source into the first portion of the second component of UV light, and the second frequency doubling component converts the light from the second laser light source into the second portion of the second component of UV light. The first portion of the second component of UV light has a frequency that is two times the frequency of the light received by the first frequency doubling component from the first laser light source, and the second portion of the second component of UV light has a frequency that is two times the frequency of the light received by the second frequency doubling component from the second laser light source. The frequency doubling components do not convert a portion of the laser light and emit the portion of light that is not converted as unconverted light.

In an exemplary embodiment of the light source, the light source further includes a first filter that blocks at least a portion of the unconverted light emitted by the first frequency doubling component, and a second filter that blocks at least a portion of the unconverted light emitted by the second frequency doubling component.

In an exemplary embodiment of the light source, the LED includes a plurality of LEDs that includes a first LED that emits a first portion of the first component of UV laser light, and a second LED that emits a second portion of the second component of UV laser light having a peak wavelength different from the peak wavelength of the first portion of the first component of UV light, wherein the peak wavelength of each of the first and second portions of the first component of UV light is greater than or equal to 250 nm and less than or equal to 400 nm.

In an exemplary embodiment of the light source, the light source further includes a beam combining element that spatially overlaps the first component of UV light and the second component of UV light to generate a combined UV light that is emitted from the light source at a common location.

Another aspect of the invention is a treatment device for treating a fluid, solid or surface. The treatment device includes the described light source and at least one of a container containing a fluid to be treated, or a solid or surface to be treated. UV light from the light source is applied to treat the fluid, solid or surface.

In an exemplary embodiment of the treatment device, the container includes a pipe through which the fluid being treated flows, and the pipe is transparent to the UV light.

Another aspect of the invention is a method of generating a treating UV light for use in treating a fluid, solid or surface. The method includes the steps of providing a light emitting diode (LED) that emits a first component of ultraviolet (UV) light, providing a UV laser light source that emits a second component of UV light having a peak wavelength different from a peak wavelength of the first component of UV light, and emitting a treating UV light including the first component of UV light and the second component of UV light. The treating UV light is applied to treat the fluid, solid or surface.

In an exemplary embodiment of the method of generating a treating UV light, the method further includes the step of providing a doubling component that receives light from the laser light source and converts at least a portion of the light into the second component of UV light, wherein the second component of UV light has a frequency that is two times the frequency of the light received by the frequency doubling component from the laser light source.

Another aspect of the invention is a method of treating a fluid, solid or surface. The method of treating includes the steps of generating a treating UV light as described above, providing at least one of a container containing a fluid to be treated, or a solid or surface to be treated, and treating the fluid, solid or surface by applying the treating UV light to the fluid or surface.

In an exemplary embodiment of the method of treating, treating the fluid, solid or surface includes at least one of sterilizing the fluid, solid or surface, or forming photocatalytic molecules in the fluid or on the solid or surface.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The device in accordance with the present invention may be used in products designed for preparation of safe drinking water, such as through the sterilization of pathogens. The device in accordance with the present invention may also be used to sterilize pathogens in air in an air handling products. The device in accordance with the present invention may also be used in products designed to sterilize pathogens on surfaces.

1. A light source for use in a treatment device for treating a fluid, solid or surface, the light source comprising:
a light emitting diode (LED) that emits a first component of ultraviolet (UV) light; and
a UV laser light source that emits a second component of UV light having a peak wavelength different from a peak wavelength of the first component of UV light;
wherein the first component of UV light and the second component of UV light are applied to treat the fluid, solid or surface.

2. The light source of claim 1, wherein the peak wavelength of the first component of UV light is greater than or equal to 250 nm and less than or equal to 400 nm.

3. The light source of claim 2, wherein the peak wavelength of the second component of UV light is greater than or equal to 180 nm and less than 250 nm.

4. The light source of any of claim 1, wherein the UV laser light source comprises:
a laser light source; and
a frequency doubling component that receives light from the laser light source and converts the light into the second component of UV light;
wherein the second component of UV light has a frequency that is two times the frequency of the light received by the frequency doubling component from the laser light source, and the frequency doubling component does not convert a portion of the laser light from the laser light source and emits the portion of the light that is not converted as unconverted light.

5. The light source of claim 4, wherein the laser light source includes a laser diode.

6. The light source of claim 4, wherein the light source further comprises a filter that blocks at least a portion of the unconverted light.

7. The light source of claim 1, wherein the UV laser light source comprises a plurality of UV laser light sources, wherein each UV laser light source emits a component of UV light having a peak wavelength different from a peak wavelength of the first component of UV light.

8. The light source of claim 7, wherein the plurality of UV laser light sources comprises:
a first UV laser light source that emits a first portion of the second component of UV laser light; and
a second UV laser light source that emits a second portion of the second component of UV laser light having a peak wavelength different from the peak wavelengths of the first portion of the second component of UV light.

9. The light source of claim 8, wherein the peak wavelength of the first component of UV light is greater than or equal to 250 nm and less than or equal to 400 nm.

10. The light source of claim 9, wherein each of the peak wavelengths of the first and second portions of the second component of UV light is greater than or equal to 180 nm and less than 250 nm.

11. The light source of any of claim 8, wherein the first and second of UV laser light source respectively comprises:
first and second laser light sources; and
first and second frequency doubling components that receive light respectively from the first and second laser light sources;
wherein the first frequency doubling component converts the light from the first laser light source into the first portion of the second component of UV light, and the second frequency doubling component converts the light from the second laser light source into the second portion of the second component of UV light; wherein the first portion of the second component of UV light has a frequency that is two times the frequency of the light received by the first frequency doubling component from the first laser light source, and the second portion of the second component of UV light has a frequency that is two times the frequency of the light received by the second frequency doubling component from the second laser light source; and
wherein the frequency doubling components do not convert a portion of the laser light and emit the portion of light that is not converted as unconverted light.

12. The light source of claim 11, further comprising a first filter that blocks at least a portion of the unconverted light emitted by the first frequency doubling component, and a second filter that blocks at least a portion of the unconverted light emitted by the second frequency doubling component.

13. The light source of any of claim 1, wherein the LED comprises a plurality of LEDs that includes:
a first LED that emits a first portion of the first component of UV laser light; and
a second LED that emits a second portion of the second component of UV laser light having a peak wavelength different from the peak wavelength of the first portion of the first component of UV light, wherein the peak wavelength of each of the first and second portions of the first component of UV light is greater than or equal to 250 nm and less than or equal to 400 nm.

14. The light source of any of claim 1, further comprising a beam combining element that spatially overlaps the first component of UV light and the second component of UV light to generate a combined UV light that is emitted from the light source at a common location.

15. A treatment device for treating a fluid, solid or surface comprising:
the light source of any of claim 1; and
at least one of a container containing a fluid to be treated, or a solid or surface to be treated;
wherein UV light from the light source is applied to treat the fluid, solid or surface.

16. The treatment device of claim 15, wherein the container comprises a pipe through which the fluid being treated flows, and the pipe is transparent to the UV light.

17. A method of generating a treating UV light for use in treating a fluid, solid or surface, the method comprising the steps of:
providing a light emitting diode (LED) that emits a first component of ultraviolet (UV) light;
providing a UV laser light source that emits a second component of UV light having a peak wavelength different from a peak wavelength of the first component of UV light; and
emitting a treating UV light including the first component of UV light and the second component of UV light;
wherein the treating UV light is applied to treat the fluid, solid or surface.

18. The method of generating a treating UV light of claim 17, wherein the method further comprises the step of:
providing a doubling component that receives light from the laser light source and converts at least a portion of the light into the second component of UV light, wherein the second component of UV light has a frequency that is two times the frequency of the light received by the frequency doubling component from the laser light source.

19. A method of treating a fluid, solid or surface comprising the steps of:
generating a treating UV light according to the method of any of claim 17;
providing at least one of a container containing a fluid to be treated, or a solid or surface to be treated; and
treating the fluid, solid or surface by applying the treating UV light to the fluid or surface.

20. The treating method of claim 19, wherein treating the fluid, solid or surface comprises at least one of sterilizing the fluid, solid or surface, or forming photocatalytic molecules in the fluid or on the solid or surface.
